(19) United States
(12) Patent Application Publication
(10) Pub. No.: US 2025/0130769 A1
(43) Pub. Date: Apr. 24, 2025

(54) STOCHASTIC ROUNDING CIRCUIT

(71) Applicant: Advanced Micro Devices, Inc., Santa Clara, CA (US)

(72) Inventors: Shubh Shah, Santa Clara, CA (US); Ashutosh Garg, Folsom, CA (US); Bin He, Orlando, FL (US); Michael Mantor, Orlando, FL (US); Shubra Marwaha, Santa Clara, CA (US); Subramaniam Maiyuran, Folsom, CA (US)

(73) Assignee: Advanced Micro Devices, Inc., Santa Clara, CA (US)

(21) Appl. No.: 18/395,039

(22) Filed: Dec. 22, 2023

Related U.S. Application Data
(60) Provisional application No. 63/591,958, filed on Oct. 20, 2023.

(51) Int. Cl. G06F 7/499; G06F 7/02

(52) U.S. Cl. CPC G06F 7/49984; G06F 7/02

(57) ABSTRACT

The disclosed circuit is configured to round a value in a first number format using a random value. Using the rounded value, the circuit can convert the rounded value to a second number format that has a lower precision than a precision of the first number format. Various other methods, systems, and computer-readable media are also disclosed.

### CROSS REFERENCE TO RELATED APPLICATION

This application claims the benefit of U.S. Provisional Application No. 63/591,958, filed 20 Oct. 2023, the disclosure of which is incorporated, in its entirety, by this reference.

### BACKGROUND

Floating point numbers are commonly used by computing devices to represent a wide range of real number values for computations. Different floating point number formats can be configured for various considerations, such as storage space/bandwidth considerations, computational considerations, mathematical properties, etc. Further, different computing devices can be configured to support different formats of floating point numbers. As computing devices become more complex (e.g., having different types of hardware working in conjunction, using networked devices, etc.), and computing demands increase (e.g., by implementing machine learning models, particularly for fast decision making), support for different floating point number formats can be desirable. Although software-based support for different floating point number formats is possible, software support often incurs added latency or can otherwise be unfeasible for particular application requirements.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for hardware-based stochastic rounding.

FIGS. 2A-C are diagrams of example floating point number formats.

FIG. 3A-B is a diagram of an exemplary stochastic rounding scheme.

FIG. 4 is a flow diagram of an exemplary method for hardware-based stochastic rounding.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to hardware-based stochastic rounding. As will be explained in greater detail below, implementations of the present disclosure use a random value for rounding a value in a first number format for conversion to a second number format. By using a random value (e.g., in a stochastic rounding scheme) as part of a rounding circuit (e.g., implementing the stochastic rounding scheme), the systems and methods provided herein can reduce compounding rounding errors over successive computations to improve computing performance without incurring significant overhead. In addition, the systems and methods provided herein can improve the technical field of machine learning by allowing improved decision making by maintaining fast processing while reducing rounding errors relating to loss of precision.

In one implementation, a device for stochastic rounding includes a processing circuit configured to round a value in a first number format using a random value, and convert the rounded value to a second number format having a lower precision than a precision of the first number format.

In some examples, the processing circuit is configured to round the value by comparing the value in the first number format to the random value. In some examples, the processing circuit is configured to compare the value by adding the random value to the value in the first number format. In some examples, the random value has a lower precision than the precision of the first number format. In some examples, adding the random value to the value in the first number format affects only a least significant bit of a mantissa, in the second number format, of a sum of the value and the random value.

In some examples, the processing circuit is further configured to round the value by rounding a sum of the value and the random value. In some examples, the processing circuit is further configured to round the sum by rounding up the sum in response to the sum being positive. In some examples, the processing circuit is further configured to round the sum by rounding down the sum in response to the sum being negative. In some examples, the processing circuit is further configured to convert the rounded value by truncating the rounded value to conform to the second number format.

In one implementation, a system for stochastic rounding includes a memory for holding a value, and a processing circuit configured to add a random value to the value in a first number format to be converted to a second number format having a lower precision than a precision of the first number format, round a sum of the random value and the value, and convert the sum to the second number format.

In some examples, the random value has fewer bits than the precision of the first number format. In some examples, adding the random value to the value in the first number format affects only a least significant bit of a mantissa, in the second number format, of the sum. In some examples, the processing circuit is further configured to round the sum by rounding up the sum in response to the sum being positive. In some examples, the processing circuit is further configured to round the sum by rounding down the sum in response to the sum being negative. In some examples, the processing circuit is further configured to convert the sum by truncating the sum to conform to the second number format.

In one implementation, a method for hardware-based stochastic rounding includes (i) adding a random value to a mantissa of a value in a first number format to be converted to a second number format having a lower precision than a precision of the first number format, (ii) rounding a sum of the random value and the mantissa, and (iii) truncating the rounded sum to conform to the second number format.

In some examples, the random value has a lower precision than the precision of the first number format. In some examples, adding the random value to the mantissa in the first number format affects only a least significant bit of a mantissa, in the second number format, of the sum. In some examples, rounding the sum further includes rounding up the sum in response to the sum being positive. In some examples, rounding the sum further includes rounding down the sum in response to the sum being negative

Features from any of the implementations described herein can be used in combination with one another in accordance with the general principles described herein. These and other implementations, features, and advantages will be more fully understood upon reading the following detailed description in conjunction with the accompanying drawings and claims.

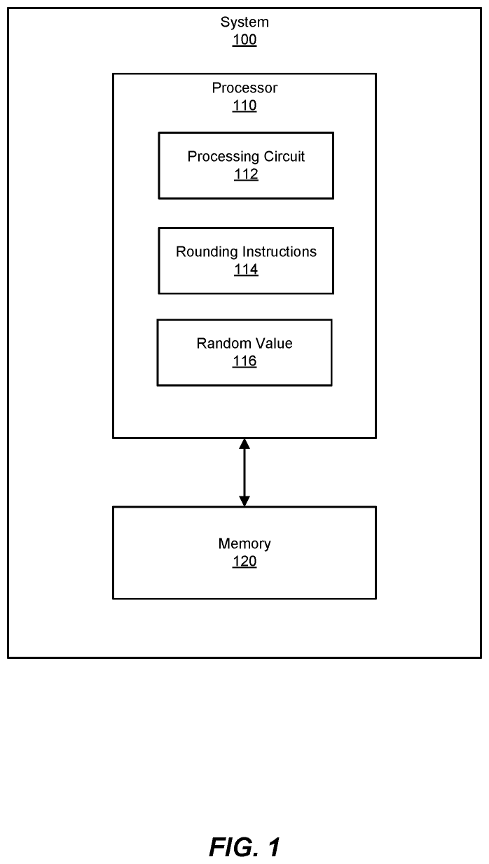

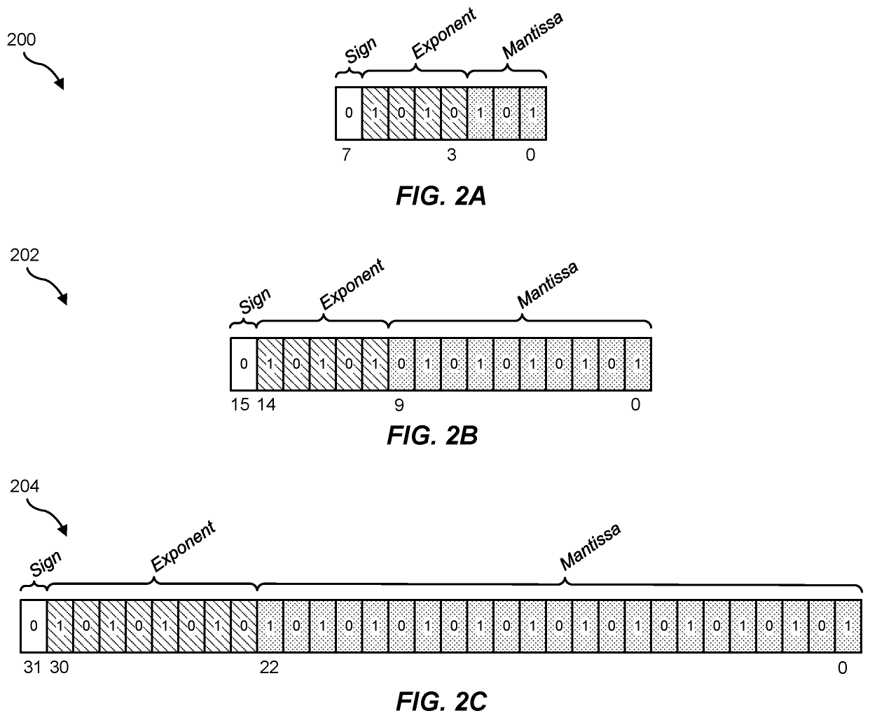

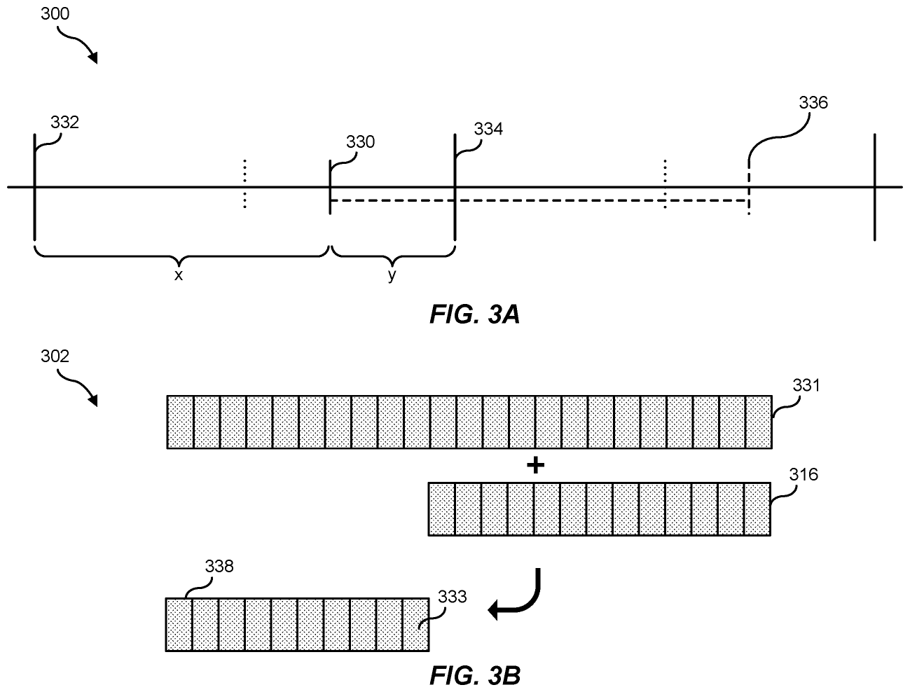

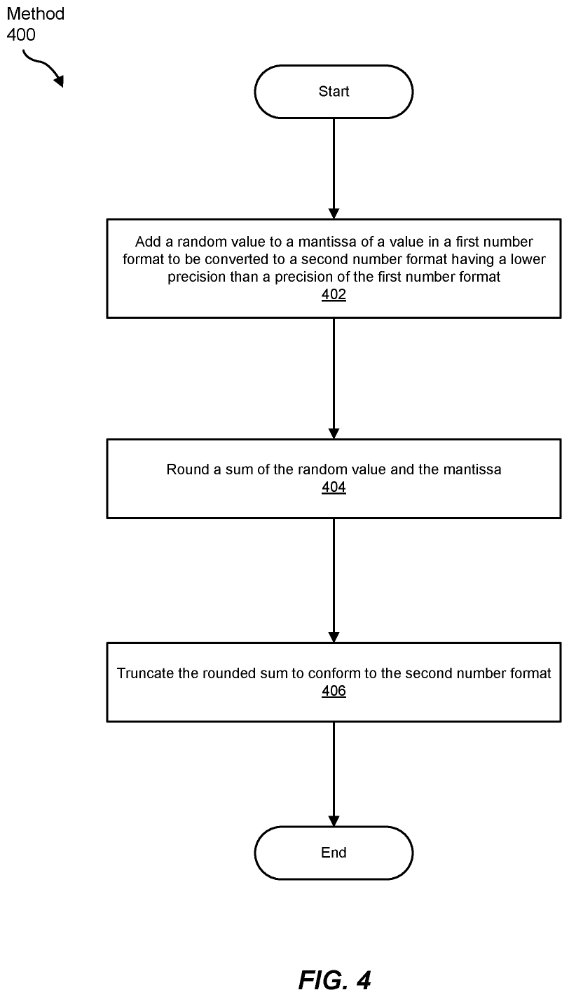

The following will provide, with reference to FIGS. 1-4, detailed descriptions of hardware-based stochastic rounding of floating point numbers. Detailed descriptions of example systems and circuits will be provided in connection with FIG. 1. Detailed descriptions of floating point number formats will be provided in connection with FIGS. 2A-2C. Detailed descriptions of a stochastic rounding scheme will be further provided in connection with FIG. 3A-3B. Detailed descriptions of corresponding computer-implemented methods will also be provided in connection with FIG. 4.

FIG. 1 is a block diagram of an example system 100 for hardware-based stochastic rounding of floating point numbers. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), co-processors such as digital signal processors (DSPs), Neural Network Engines (NNEs), accelerators, portions of one or more of the same, variations or combinations of one or more of the same (e.g., a host processor and a co-processor), and/or any other suitable physical processor(s).

In some implementations, the term “instruction” refers to computer code that can be read and executed by a processor. Examples of instructions include, without limitation, macro-instructions (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations correspond to the most basic operations achievable by a processor and therefore can further be organized into micro-instructions (e.g., a set of micro-operations executed simultaneously).

As further illustrated in FIG. 1, processor 110 includes a processing circuit 112, rounding instructions 114, and a random value 116. Processing circuit 112 corresponds to a processing component and in some examples includes circuitry and/or instructions for floating point number conversion operations and/or portions thereof, and further in some examples can correspond to and/or interface with a floating point unit (FPU) for performing floating point operations. Rounding instructions 114 correspond to circuitry and/or instructions for implementing a stochastic rounding scheme for floating point numbers, using a random value such as random value 116. In some examples, rounding instructions 114 can correspond to micro-operations that can be loaded and/or hard-wired into processing circuit 112. Random value 116 corresponds to a randomly generated number (e.g., via processor 110, processing circuit 112, and/or rounding instructions 114) which in some implementations can be regenerated as needed (e.g., each use). In some examples, random value 116 corresponds to a random number held in a kernel of an operating system (OS). Further, in some examples, random value 116 can correspond to a register of processor 110 holding the random the number. As will be described further below, processing circuit 112 can apply random value 116 in accordance with rounding instructions 114 to floating point numbers to apply a stochastic rounding scheme.

FIGS. 2A-2C respectively illustrate a number format 200, a number format 202, and a number format 204, each corresponding to floating point formats of different precisions (e.g., bit widths). For example, FIG. 2A illustrates an example 8-bit precision floating point number format, FIG. 2B illustrates an example 16-bit precision floating point number format, and FIG. 2C illustrates an example 32-bit precision floating point number format.

A floating point number corresponds to a real number value represented with significant digits and a floating radix point. For example, a decimal (real) number 432.1 can be represented, by moving (e.g., floating) the base-10 radix point (e.g., decimal point), as 4321*10\hat{ }-1, allowing a real number value to be represented by an integer (e.g., mantissa or significand) scaled by an integer exponent of a base. Because computing systems store bit sequences which are readily converted to binary (e.g., base 2) numbers, computing systems often use a base-2 radix point. For instance, 0.5 can be represented as 1*2\hat{ }-1. Thus, in a binary representation of a floating point number, a real number value, Value, can be represented by the following equation:

$$Value = {( - 1 )}^{Sign} * Normalized\_Mantissa * {2}^{Exponent - Bias} \qquad Equation 1$$

Sign can indicate whether the value is positive (e.g., Sign=0) or negative (e.g., Sign=1). Normalized_Mantissa can correspond to a mantissa (e.g., as stored in a bit sequence) that has been normalized in accordance with a floating point number format. A non-zero binary number can have its radix point floated such that its mantissa can always have a leading 1 (e.g., “1.01”). Accordingly, many floating point number formats will not explicitly store this leading 1, as it is understood (e.g., when normalized). Exponent-Bias corresponds to the final exponent of the value after subtracting Bias from Exponent. Many floating point number formats use a bias to avoid using a sign bit (e.g., for negative exponents), which can further allow efficient processing between two floating point numbers. Thus, Exponent can correspond to the stored exponent value, and Bias can be a value defined for the specific floating point number format. Further, floating point number formats can define how bits in an allotted bit width can be decoded or interpreted. Thus, certain bits can be reserved for representing Sign, certain bits can be reserved for representing Exponent, and certain bits can be reserved for representing a Mantissa that can require normalizing.

Turning to FIG. 2A, number format 200 represents an example of an 8-bit floating point number format (e.g., having an 8-bit width or precision such as quarter-precision). Number format 200 can define what each bit position of the 8-bit format represents. As illustrated in FIG. 2A, a single bit (e.g., bit 7) can correspond to a sign bit (e.g., Sign), four bits (e.g., bits 3-6 from least to most significant bits) can correspond to an exponent (e.g., Exponent), and three bits (e.g., bits 0-2 from least to most significant bits) can correspond to a mantissa. In other number formats, a number and/or order of bits for the various elements can vary. In addition, a bias (e.g., Bias) can be defined for number format 200. For example, the bias can be 7, corresponding to exponents ranging from −6 to 7, which are derived from subtracting the bias 7 from a range of 1-14 for the four bits (leaving “0” or all 0s and “15” or all 1s for special values). The bias can be based on the number of exponent bits. In some examples, the bias allows certain bit sequences (e.g., bit sequences having the exponent being all 0, as well as other particular bit sequences such as all 0, etc.) to represent special values (e.g., subnormal values, positive/negative zero, positive/negative infinity, undefined/not a number (NaN), etc.).

FIG. 2B illustrates number format 202 that represents an example of a 16-bit floating point number format (e.g., half-precision). As illustrated in FIG. 2B, a single bit (e.g., bit 15) can correspond to a sign bit (e.g., Sign), five bits (e.g., bits 10-14 from least to most significant bits) can correspond to an exponent (e.g., Exponent), and ten bits (e.g., bits 0-9 from least to most significant bits) can correspond to a mantissa. The bias can be based on the number of exponent bits, such as 15, which can further reserve certain bit sequences as special values as described herein. In other examples, number format 202 can have different number and/or order of bits for the various elements.

FIG. 2C illustrates number format 204 that represents an examples of a 32-bit floating point number format (e.g., single-precision). As illustrated in FIG. 2C, a single bit (e.g., bit 31) can correspond to a sign bit (e.g., Sign), eight bits (e.g., bits 23-30 from least significant to most significant bits) can correspond to an exponent (e.g., Exponent), and twenty-three bits (e.g., bits 0-22 from least significant to most significant bits) can correspond to a mantissa. The bias can be based on the number of exponent bits, such as 127, which can further reserve certain bit sequences as special values as described herein. In other examples, number format 204 can have different number and/or order of bits for the various elements.

In some examples, system 100 (e.g., processor 110) can be configured with circuitry and/or instructions for particular floating point number formats. For example, certain elements of a number format (e.g., bias, special value sequences, etc.) can be incorporated into the circuitry and/or instructions without explicitly storing such elements in the floating point number (e.g., bit sequence) itself. In some implementations, processor 110 can include circuitry and/or instructions for each supported floating point number format (e.g., processing circuit 112 and/or rounding instructions 114 can correspond to multiple iterations).

In some examples, it can be desirable to convert values between different number formats. For example, processor 110 can process values in a higher precision (e.g., higher bit-width) number format for precision, and output the resulting values in a lower precision (e.g., lower bit-width) number format to reduce bandwidth/storage. Thus, processor 110 can convert values from a higher precision floating point number format to a lower precision (e.g., lower bit-width) floating point number format. However, based on how the number formats are defined, a loss of precision can be unavoidable. For instance, when converting number format 204 to a lower precision format (e.g., number format 202 and/or number format 200), a reduced number of bits for the mantissa results in the loss of precision, requiring the mantissa to be converted to an available mantissa value in the lower precision format. Various rounding schemes can be used, such as rounding to the nearest (with ties rounding to the nearest even digit or alternatively away from zero), rounding up, rounding down, and round towards zero (e.g., truncation in which remaining digits are dropped). Although such rounding schemes can produce a good result for an isolated value, with successive operations on rounded values, the rounding error can be compounded which over time can create significant deviations from actual values.

FIGS. 3A-3B illustrate a stochastic rounding scheme that can be applied to floating point numbers (e.g., using processing circuit 112 and/or rounding instructions 114). FIG. 3A illustrates a diagram 300 corresponding to a number line and includes a first value 332, a second value 334, an actual value 330, and a max potential value 336. Actual value 330 corresponds to a value in a higher precision number format, for conversion to a lower precision number format, represented by first value 332 and second value 334 (e.g., long hash marks). As illustrated in FIG. 3A, actual value 330 is between adjacent values of first value 332 and second value 334 such that rounding actual value 330 can result in the rounded value being first value 332 or second value 334 based on an applied rounding scheme.

Commonly used rounding schemes can be deterministic in that a given value will always be rounded to the same result (e.g., actual value 330 will always round to second value 334 when rounding to the nearest). However, stochastic rounding applies a probability of a given value will round to an adjacent value based on, for example, a distance to the adjacent value. For example, in FIG. 3A, given a total distance (x+y) between adjacent value (which further corresponds to a limit of precision in the lower precision number format), a probability that actual value 330 will be rounded to first value 332 is (1−x)/(x+y), and a probability that actual value 330 will be rounded to second value 334 is (1−y)/(x+y). In other words, because actual value 330 is closer to second value 334, actual value 330 is more likely to be rounded to second value 334 than to first value 332.

In one implementation, this stochastic rounding can be applied by using a random value (e.g., corresponding to random value 116) that can have a value between 0 and (x+y) and compared to actual value 330. The values can be compared, in some implementations, by adding this random value to actual value 330, resulting in a sum potentially having a value between max potential value 336 and actual value 330. The sum can be truncated (e.g., by removing any value in excess of an adjacent value). For example, if the sum is between actual value 330 (inclusive) and second value 334 (exclusive), truncation results in first value 332. If the sum is between second value 334 (inclusive) and max potential value 336 (exclusive), truncation results in second value 334. As illustrated in FIG. 3A, a range of potential values between actual value 330 and second value 334 is less than a range of potential values between second value 334 and max potential value 336, such that a likelihood of actual value 330 being rounded to first value 332 or second value 334 corresponds to the probabilities described above.

Although FIG. 3A illustrates an example of stochastic rounding, in other implementations, variations can be further applied, such as applying a similar or modified scheme for negative numbers. For example, rather than truncating, in some examples the sum can be rounded (e.g., rounding up when the sum is positive, rounding down when the sum is negative, etc.). Moreover, although FIG. 3A refers to actual value 330, in some implementations, the stochastic rounding scheme as described herein can be applied to a mantissa of actual value 330, as described further with respect to FIG. 3B.

FIG. 3B illustrates a diagram 302 of a mantissa 331 (e.g., a mantissa of actual value 330), a random value 316 (e.g., the random value described above and further corresponding to random value 116), and a rounded value 338 having a least significant bit 333. FIG. 3B illustrates the values as bit sequences. For instance, mantissa 331 corresponds to a mantissa of number format 204 (e.g., the 32-bit precision format) and rounded value 338 corresponds to a mantissa of number format 202 (e.g., the 16-bit precision format), although in other examples other formats can be used. As illustrated in FIG. 3, random value 316 can have fewer bits than number format 204 (and/or a mantissa thereof) such that random value 316 can correspond to having less precision than number format 204.

Processing circuit 112 can select random value 316 such that, when processing circuit 112 (e.g., via rounding instructions 114) adds random value 316 to mantissa 331, only least significant bit 333 of rounded value 338 is affected. Accordingly, after processing circuit 112 sums mantissa 331 with random value 316 and truncates the result (e.g., by discarding excess bits beyond an available bit width of number format 202 to conform to number format 202, as illustrated in FIG. 3B), processing circuit 112 can achieve the stochastic rounding as described herein (e.g., in FIG. 3A), which in some examples further allows processing circuit 112 to convert values of number format 204 to number format 202.

FIG. 4 is a flow diagram of an exemplary computer-implemented method 400 for hardware-implemented stochastic rounding. The steps shown in FIG. 4 can be performed by any suitable computer-executable code and/or computing system, including the system(s) illustrated in FIG. 1. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein add a random value to a mantissa of a value in a first number format to be converted to a second number format having a lower precision than a precision of the first number format. For example, processing circuit 112 can add random value 116 to a mantissa of a value (e.g., read from data, instructions and/or values stored in memory 120) in a first number format to be converted to a second number format of lower precision.

The systems described herein can perform step 402 in a variety of ways. In one example, random value 116 has a lower precision (e.g., bit width) than the precision of the first number format. In some examples, adding the random value to the mantissa in the first number format affects only a least significant bit of a mantissa, in the second number format, of the sum

At step 404 one or more of the systems described herein round a sum of the random value and the mantissa. For example, processing circuit 112 rounds a sum of random value 116 and the mantissa.

The systems described herein can perform step 404 in a variety of ways. In some examples, rounding the sum further includes rounding up the sum in response to the sum being positive. In some examples, wherein rounding the sum further includes rounding down the sum in response to the sum being negative

At step 406 one or more of the systems described herein truncate the rounded sum to conform to the second number format. For example, processing circuit 112 can truncate the rounded sum to conform to the second number format.

As detailed above, in machine learning models, values are often converted between high precision (FP32, FP16) and low precision (FP8) values, which requires rounding of values and values can get truncated. Rounding can also result in a loss of precision. Consistent application of a particular rounding scheme (rounding up or to the nearest number) can over time lead to nontrivial loss of precision. Specifically, in neural networks, which have 3-4 bit mantissa values, rounding can be a significant issue.

The systems and methods described herein provide a probabilistic-based or stochastic rounding scheme. Rather than rounding up or to the nearest number, this rounding scheme uses an addition with a random number of a smaller size, and then truncating. Thus, the Most Significant Bits can be unaffected while only affecting the Least Significant Bit. This further allows avoiding double rounding.

The stochastic rounding scheme can be implemented in hardware, for example in a circuit for converting FP32 to FP8. A random number (having fewer bits) can be held in kernel. This random number can be added to the conversion value, which would only affect the LSB. By truncating this summed value, the desired value can be derived without rounding.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processing circuit configured to:
round a value in a first number format using a random value; and
convert the rounded value to a second number format having a lower precision than a precision of the first number format.

2. The device of claim 1, wherein the processing circuit is configured to round the value by comparing the value in the first number format to the random value.

3. The device of claim 2, wherein the processing circuit is configured to compare the value by adding the random value to the value in the first number format.

4. The device of claim 3, wherein the random value has a lower precision than the precision of the first number format.

5. The device of claim 3, wherein adding the random value to the value in the first number format affects only a least significant bit of a mantissa, in the second number format, of a sum of the value and the random value.

6. The device of claim 3, wherein the processing circuit is further configured to round the value by rounding a sum of the value and the random value.

7. The device of claim 6, wherein the processing circuit is further configured to round the sum by rounding up the sum in response to the sum being positive.

8. The device of claim 6, wherein the processing circuit is further configured to round the sum by rounding down the sum in response to the sum being negative.

9. The device of claim 2, wherein the processing circuit is further configured to convert the rounded value by truncating the rounded value to conform to the second number format.

10. A system comprising:
a memory for holding a value; and
a processing circuit configured to:
add a random value to the value in a first number format to be converted to a second number format having a lower precision than a precision of the first number format;
round a sum of the random value and the value; and
convert the sum to the second number format.

11. The system of claim 10, wherein the random value has fewer bits than the precision of the first number format.

12. The system of claim 10, wherein adding the random value to the value in the first number format affects only a least significant bit of a mantissa, in the second number format, of the sum.

13. The system of claim 10, wherein the processing circuit is further configured to round the sum by rounding up the sum in response to the sum being positive.

14. The system of claim 10, wherein the processing circuit is further configured to round the sum by rounding down the sum in response to the sum being negative.

15. The system of claim 10, wherein the processing circuit is further configured to convert the sum by truncating the sum to conform to the second number format.

16. A method comprising:
adding a random value to a mantissa of a value in a first number format to be converted to a second number format having a lower precision than a precision of the first number format;
rounding a sum of the random value and the mantissa; and
truncating the rounded sum to conform to the second number format.

17. The method of claim 16, wherein the random value has a lower precision than the precision of the first number format.

18. The method of claim 16, wherein adding the random value to the mantissa in the first number format affects only a least significant bit of a mantissa, in the second number format, of the sum.

19. The method of claim 16, wherein rounding the sum further includes rounding up the sum in response to the sum being positive.

20. The method of claim 16, wherein rounding the sum further includes rounding down the sum in response to the sum being negative.
